(19) United States
(12) Patent Application Publication
(10) Pub. No.: US 2012/0278228 A1
(43) Pub. Date: Nov. 1, 2012

(54) METHOD AND APPARATUS FOR ACCURATE AND SECURE PRODUCT DISPENSING

(75) Inventor: Marshal Saul Rubinstein, Suffolk Park (AU)

(73) Assignee: TRANQUILITY GROUP PTY LTD, Riverview, NSW (AU)

(21) Appl. No.: 13/520,134

(22) PCT Filed: Jan. 4, 2011
(86) PCT No.: PCT/AU2011/000001

§ 371 Date: Jun. 29, 2012

(30) Foreign Application Priority Data
Dec. 30, 2009 (AU) 2009906316

(51) Int. Cl. G07F 7/00; G06Q 40/00

(52) U.S. Cl. 705/39; 221/174; 221/2; 221/6

(57) ABSTRACT

A system and apparatus for accurate and secure dispensing of products using an automated dispensing machine, and transmission, processing and analysis of data concerning items dispensed. In one embodiment the system provides the possibility of combined pharmaceutical supply chain management and medication treatment compliance management and may be applied to controlled dispensing of medications, enabling incentives to encourage higher compliance, recording and processing of patient and health care data. The system allows for automatic replenishment of medications to the RFID equipped medication storage enclosure at the healthcare site. It also allows for complete logging of data relating to which patient has received the correct dosage at what time, by whom this medication was administered, and correlation with other possible RFID tagged documents.

### TECHNICAL FIELD

The present invention generally relates to a product dispenser for dispensing a product. The invention relates to dispensing any product including, for example, prescription medications, and snack foods and beverages in hotels.

### BACKGROUND ART

The reference to any prior art in this specification is not, and should not be taken as an acknowledgement or any form of suggestion that the prior art forms part of the common general knowledge.

There is an increasing need for a system and apparatus for safely and securely dispensing products at remote locations, where the dispensing of such products is securely limited to specific authorized persons and furthermore where safeguards exist to ensure that only the correct product type and quantity are dispensed. Such applications include dispensing of prescription medications in Hospitals, General Practitioners rooms and Aged Care facilities. Traditionally prescription medications are distributed using a pharmacy distribution model, whereby pharmacists provide the security and accuracy required to ensure safe distribution of medications. In many scenarios this traditional pharmacy distribution model may be impractical and it is often necessary to store prescription medications in remote locations for dispensing by healthcare workers. For example in third world countries there may not be a pharmacy available in a small town and emergency medications need to be stored locally for emergencies. Hospitals and Aged Care facilities have a similar need to store and accurately dispense medications. Oil rigs and other remote locations also have such a need to store and safely dispense medications. In such applications it is of critical importance that the correct type of medication and the correct quantity of medication is dispensed, and any error made can have serious implications for human health. Furthermore, in order to be a practical solution, any system for automated dispensing must be able to dispense a wide variety of medications, with packaging of varying physical dimensions. Any practical solution should also be capable of providing refrigeration for medications requiring a cool storage environment.

Existing vending machines, while capable of dispensing products at remote locations, lack the specific functionality and safeguards necessary for accurate and secure dispensing in critical applications such as healthcare medication dispensing. Existing machines are often used to dispense products where a demand for a product exists in a location or at a time of day which would make it impractical for a traditional retail store to satisfy said demand for products. These vending machines may typically dispense items such as soft drinks and snack foods. These vending machines, for example Snack food vending machines, lack the necessary safeguards to ensure that only the correct medication type and quantity is dispensed to only the correct authorized person. Typically these machines only require some form of payment, such as bank notes, coins or credit card payments, before they will automatically dispense the product selected by the customer. There is usually no way to restrict dispensing of particular items to particular authorized persons. Usually these vending machines are specifically designed to accommodate products of a particular physical dimension, for example cans of soft drink, and usually a different type of vending machine mechanism is required for different types of products (eg. Cigarettes would require a different mechanism than a soft drink can vending machine). It is possible that during a refilling operation of such a vending machine, that the incorrect product could be loaded into a particular product slot, resulting in the incorrect item being dispensed. Furthermore there is a possibility in many vending machines of products “jamming” and getting stuck in the internal workings of the machine, resulting in either no product being dispensed, the wrong item being dispensed, or even several items being dispensed instead of only the one that was ordered. In summary, existing vending machines suffer the following limitations which make them impractical in critical applications such as healthcare medication dispensing: Lack of flexibility in accommodating a wide variety of product types in a single machine, Lack of security features which can limit dispensing of specific products to specific authorized persons, Lack of safeguards to ensure that refilling errors cannot occur and result in the incorrect product being dispensed, Lack of safeguards to ensure dispensing errors cannot result in the incorrect quantity or type of product being dispensed.

Embodiments of the present invention provide for accurate and secure dispensing of products which ameliorate deficiencies in existing dispensing arrangements, or provide a useful commercial choice.

### SUMMARY OF THE INVENTION

According to one aspect of the present invention, there is provided a product dispenser for dispensing a product, the dispenser including:

a compartment; and

a product hanging arrangement located within the compartment, the hanging arrangement including a retractable hanging member upon which the product can be hung.

The hanging arrangement may further include a solenoid which, upon actuation, retracts the hanging member so that the product falls from the hanging member. The product dispenser may further include a drawer located at the base of the compartment for receiving the fallen product and which can be opened so that the product can be retrieved.

The product dispenser may further include a RFID reader for reading a RFID tag of the product. The product dispenser may further include a controller configured to detect the identity of the read RFID tag and to generate an incorrect product alarm responsive to the detected identity not matching a predetermined identity thereby indicating that an incorrect product has been loaded. The product may be a medicinal product, and the controller may be configured to retract the hanging member only upon the detected identity relating to a prescription. Alternatively, the product may include a foodstuff or beverage, and the dispenser may further include a controller configured to detect the absence of the read RFID tag and generate a refill alarm.

In one embodiment, the product dispenser further includes: a plurality of other product hanging arrangements; RFID antennae located proximal respective hanging arrangements; a RF multiplexer arrangement in communication with the antennae; and a RFID reader coupled to the RF multiplexer and configured to individually read RFID tags located proximal the RFID antennae.

Preferably, the product dispenser further includes the product, the product including a consumable and a hanger for hanging the consumable on the hanging member. The hanger may include a hook, and either an RFID tag to be read by a RFID reader or a conductor to be sensed by a proximity sensor.

The compartment may be refrigerated. The product dispenser may be a hotel minibar. The minibar may be coupled to a hotel Property Management System (PMS) to thereby enable the dispensed product to be automatically charged to an account. The compartment may include a transparent front portion. The dispenser may further include a plurality of other product hanging arrangements arranged in one or more rows extending from the transparent front portion, the hanging arrangements in each row being configured to be actuated to dispense the products sequentially from the rear of the compartment toward the front portion.

The product dispenser may further include a proximity sensor for sensing the presence or absence of a conductor of the product. The product dispenser may further include a touch screen or other like user interface to facilitate selection of the product to be dispensed. The product dispenser may further include authorization means for enabling authorized access to the compartment. The authorization means may include any one or more of a key, a RFID access card, a fingerprint authenticator, an iris authenticator a biometric access means, and a keypad for receiving a entry code.

According to another aspect of the present invention, there is provided a product for a product dispenser, the product including a hanger for hanging upon a retractable hanging member of the dispenser.

An embodiment of the present invention provides an apparatus for securely and accurately dispensing products from a compartment, which comprises a plurality of mechanisms capable of automatically holding and releasing products (referred to herein as the Hold/Release mechanism), a hook assembly attached to each product being dispensed, with said hook assembly fitting securely onto the hold/release mechanism, a plurality of RFID tags, with one tag fitted to each product hook assembly, a plurality of Radio Frequency Identification (RFID) antennae, with at least one attached to each hold/release mechanism in an orientation and location allowing for the detection of the RFID tags attached to the hook assembly, an RFID reader attached to said RFID antennae, a processor, coupled to said RFID reader, for the purpose of processing the RFID tag information and identifying which items are attached to the Hold/Release mechanism and a slide drawer into which items dispensed may drop into. The slide drawer allows a user to take the dispensed item out of the dispensing machine, but does not allow the user to replace the item or retrieve items that have not been dispensed. In the embodiment of a refrigerated dispensing unit, the slide drawer has the added benefit of maintaining a cool environment for the dispensed item, until such time as it is removed by the user. The Hold/Release mechanism is comprised of an electrical solenoid with a spring attached. The spring ensures the solenoid plunger shaft is extended when power is not applied to the solenoid. The extended plunger shaft supports the hook of the hook assembly, which is attached to the product to be dispensed. The hook assembly may be directly or indirectly attached to the product to be dispensed. For example, in the case of direct connection of the hook to the product, the hook assembly may be stuck directly to the product using a suitable adhesive product such as double sided tape. An example of an in-direct connection may be a clear plastic bag attached to the hook assembly, which the product securely inserted into the clear plastic bag. When power is applied to the solenoid, the plunger shaft is pulled into the solenoid housing, and the hook assembly is no longer supported and drops downwards, together with the attached product, into the slide draw. It may then be collected by the user, who pulls out the slide draw and retrieves the product. The user may remove the product, but is unable to place products inside the machine or retrieve products stored in the machine that have not been dispensed.

In one embodiment, replacement of consumed products is only possible by authorized refill personnel, who will have access to the main front panel door, via either a key, pass-code entered into keypad, RFID access card, biometric verification such as iris scanner or fingerprint reader, or any other convenient security access method, or combination thereof. The refill personnel will have previously received a refill report detailing the items required to perform the refill. This is made possible since each time the system dispenses a product, it communicates the transaction via a network connection to one or more central servers, and the central server is able to remotely monitor the inventory present in the dispensing machine at any time. Correct replacement of consumed items in the correct location in the dispensing machine is verified by reading the information stored on the RFID tag present on the hook assembly. A feedback mechanism is included in an embodiment of the invention to give confirmation to the refill personnel that they have placed the correct item in the correct location. This may be for example an LED indicator displaying a Green illumination when the correct item is replaced, and a red illumination when the incorrect item is replaced. There may also be an audible alarm activated when the product dispensing location is re-loaded with an incorrect item.

In this document the term “compartment” is used to describe either “a fridge or any other area or compartment” where inventory control and automated dispensing action may be applied. For example, in some embodiments the compartment may be an un-refrigerated cabinet, wherein in others it may be a refrigerated enclosure.

In certain embodiments of the invention, the apparatus may be configured to dispense particular products based on a unique identifier presented to the machine by the user. For example, the system of the current embodiment may include a system of hardware and software to allow a doctor to enter in prescription information into a computer terminal (hereinafter referred to as the “electronic prescription generating system”). This information may include a patient's name, the medication prescribed, and other pertinent information relating to the medication prescription. This data may then be stored in a central database. The said computer system may then generate a unique identification number sequence, which is entered into the automated dispensing machine of the current embodiment by either the patient or an authorized healthcare worker. Upon receiving this unique identification number sequence, the automated dispensing machine may reference the particular information in the central database, it may, if required, verify credentials for security purposes (this may include biometric, fingerprint scanner, iris scanner or other suitable verification methods), and thereafter dispense the required medication. The dispensing machine may thereafter update the database so that the unique identification number cannot be used again. The benefit of this scheme is that the unique identification number sequence could be communicated to persons at a remote location, for example by phone, and this would allow the person immediate access to medication stored in the remote dispensing machine immediately, without them having to wait to receive a physical prescription, which may otherwise need to be sent by other means, for example mail.

In another embodiment, instead of generating a unique identification sequence to be entered into the machine, the electronic prescription generating system may relate a particular RFID tag or Bar Code to the records of a particular electronic prescription in the database. In the case of an RFID Tag, it may optionally encode further data on the actual RFID tag, for example referring to the number of repeats available on the prescription. In such an embodiment, the user simply presents the Bar Code to the Dispensing machines Bar Code Reader, or alternatively presents the RFID tag within the field of sensitivity of an RFID Reader antenna located on the outside surface of the dispensing machine. The dispensing machine will read the prescription's RFID tag (or Bar Code), and reference the relating data from the central database. It may then optionally verify security credentials (e.g. Using Biometric verification) before dispensing the correct medication. Prior to dispensing medication, it may also write information to the prescription's RFID tag, such as decrementing the data indicating the number of repeats available on the prescription, voiding the prescription, or recording any other pertinent data onto the prescription's RFID tag. Privacy may optionally be preserved by not storing specific patient data and patient names on the prescriptions RFID tag, and the central database may furthermore be restricted to the product that was prescribed, and not contain any personal data. In this way it is possible to preserve anonymity and privacy in the system if required, and in this case having possession of the prescription's RFID tag (or in the case of Bar Codes being utilized, the bar code label) would be all that is required by the patient or healthcare worker in order to access the medication stored in the dispensing unit.

In certain embodiments, it may not be necessary to securely restrict which products may be dispensed, and in such cases the product selection may be made via a suitable input device located on the front panel of the dispensing machine. For example, a dispensing machine located in a hotel's guest room may be configured to dispense snack foods and drinks. In such a case a touch screen or other suitable input device (for example buttons) may be pressed by the user in order to make their selection. In such a case, the plurality of dispensing machines throughout the hotel may be connected to a central server, and the central server may communicate to the hotel's property management system (PMS), allowing the charges for items dispensed to be automatically posted to a guest room folio or account. Numerous products may be attached to the “hold/release” mechanisms arranged in rows, allowing several of each type of product to be dispensed. This would allow the machine to be refilled infrequently, since there would be multiples of each type of product available for consumption. Furthermore the system may be configured to “drop” items preferentially from the rear of the unit, so that in the case of a glass fronted dispensing machine from which the rows of “hold/release” mechanisms extend, the machine would still look “full” until the last of a particular type of item was consumed.

In certain embodiments, it may not be as critical to ensure safeguards, to ensure the correct item has been loaded. For example in an application involving snack foods, an incorrectly loaded snack item, while inconvenient and annoying for customers, would not present a risk to human health. In such embodiments it may be preferred to save the costs of having a disposable RFID tag attached to each product (via the Hook Assembly). In such eases the present embodiment offers an innovative way of preserving the detection capability of the RFID tag without making it a disposable item. This method involves applying the RFID tag directly onto the surface of the RFID reader antenna corresponding to the dispensed products “Hold/Release” mechanism. Instead of an RFID label being applied to the Hook Assembly (as in the usual operating mode), a conductive metal foil sticker is applied to the Hook Assembly in the same place as the RFID label is usually placed. When the Hook Assembly, with product attached, is placed on the Hold/Release mechanism, the foil sticker has the effect of de-tuning the RFID label, resulting in it not being readable. As a consequence, the system is able to detect the presence of the product by establishing a “no read” condition for the RFID label relating to that specific Hold/Release mechanism, and the RFID Reader/Tag arrangement functions in a similar way as a proximity sensor, detecting the presence or absence of the product based on whether the RFID tag stuck on the antenna is readable or non-readable. This mode of operation is therefore hereinafter referred to as “proximity detection mode”. When operating in “proximity detection mode” it is not possible to detect if the incorrect item has been placed on a particular Hold/Release mechanism, but in certain applications, the reduced operating costs resulting from preserving the RFID tags may outweigh this loss of safeguards, and in non-critical applications this mode of operation may be preferable. A dispensing machine may operate in either “proximity detection mode” or full RFID inventory management mode, or even a mixture of the two, as would be determined by the economics of the application.

In addition to the accurate and secure dispensing of products, the current embodiment also provides the option of monitoring and recording details relating to whom the product has been dispensed to. This is of particular importance in certain applications, for example in the dispensing of medication. The health care industry often seeks to monitor the rates of compliance of patients to a particular treatment plan. For example in the case of a patient being prescribed a course of injections over a period of time, it is desirable to be able to monitor the patient's compliance and identify if injections have been omitted. It is also desirable to find ways to encourage patient compliance and provide incentives for patients to comply with their treatment programme. The present embodiment makes such monitoring and incentives possible, since the dispensing of the medication to a particular customer can be recorded automatically in a database, and the central processing server is able to automatically generate reports and messages to various external computer systems to enable monitoring of patient compliance. The embodiment is also able to send information concerning compliance to third parties. In such a way it is possible to offer incentives to patients to reward them for complying with their treatment programme, for example the system may advise the health insurance company that a patient has complied with their treatment programme, and the health insurance company may reward the patient with a rebate or other benefit as an incentive.

### BRIEF DESCRIPTION OF THE DRAWINGS

A small number of embodiments are described hereinafter, by way of example only, with reference to the accompanying drawings in which:

FIG. 1 is a view of a Hook Assembly, according to an embodiment of the present invention;

FIG. 2 is a simplified view illustrating the principle of operation of the Dispensing Apparatus in “Hold” mode, according to an embodiment of the present invention;

FIG. 3 is a simplified view illustrating principle of operation of the Dispensing Apparatus in “Release” mode, according to an embodiment of the present invention;

FIG. 4 is a block diagram illustrating an embodiment demonstrating the transmission, reception and processing of data between the dispensing apparatus and various external elements, and methods to optimize supply chain factors and increase medical treatment compliance;

FIG. 5 is a block diagram of an apparatus for Accurate and Secure Dispensing of products, according to an embodiment of the present invention;

FIG. 6 is a block diagram featuring a plurality of Accurate and Secure Dispensing Apparatus, connected together to form a network; and

FIG. 7 is a schematic representation of a computer system that can be used to practice embodiments of the present invention.

### DETAILED DESCRIPTION OF PREFERRED EMBODIMENTS

Embodiments of apparatuses and systems are described herein for Accurate and Secure Dispensing of products, managing stock items, and monitoring the consumption of said items, recording the details of whom consumed said items, and implementing methods to increase the consumption of said items through use of mathematical analysis of data, the use of reminder messages, and the use of incentives directed towards consumers. The embodiments are generally described with reference to pharmaceutical medicines stored at health care locations such as GP's medical practices, and patients who are prescribed the said medicines. However, it is not intended that the invention be limited to such application. For example, the invention has application to numerous other compartments and/or refrigerated compartments, such as laboratory fridges, vets practices, storing and/or dispensing blood, dispensing of snack foods and drinks, consumer products etc.

Every RFID tag has a unique Tag Identification Number (Tag ID). Some RFID tags have a feature enabling additional information to be stored on the RFID tag, in addition to its Tag ID.

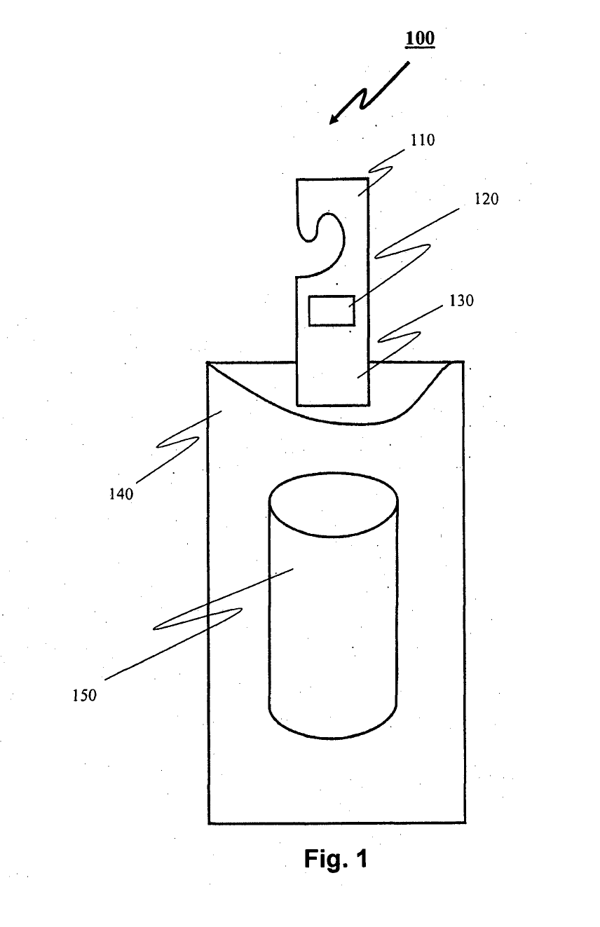

FIG. 1 shows an assembly arrangement 100 or product, referred hereinafter as a “Hook Assembly”. The Hook Assembly 100 consists of a hook 110, which may be made of plastic sheeting, plastic extrusion or any other convenient material. It is typically of a considerably flat nature, being quite thin, in order for it to fit comfortably onto the shaft of the Hold/Release mechanism to be described later. The Hook 110 has a curved area which is profiled to fit neatly on shaft of the Hold/Release mechanism. There is a sticker tag 120 applied to the Hook 110 at a specific location on the Hook which corresponds to the region of sensitivity of the RFID Antenna located on the Hold/Release Mechanism. The sticker tag 120 may be either an RFID Tag (in the case of the embodiment operating in “Full RFID inventory management” mode), or alternatively a conductive metallic material such as a foil material (in the case of the embodiment operating in “proximity detection” mode). The Hook 110 has an area 130 which is coated with strong adhesive material or other material or mechanism which allows fastening of the hook 110 to a product or product packaging.

In the embodiment illustrated, the hook 110 is attached via adhesive glue or tape, to a plastic bag 140, which is open at the top, and sealed at the bottom. Consumable 150 to be dispensed is inserted into the bag, and may be of any shape, with the only restriction being that the physical size be contained within the bag 140. In other embodiments the hook 110 may be directly attached to a product via adhesive glue or tape 130. In other embodiments hook 110 may be attached directly to products via a physical attachment method, such as an elastic material which grips the product and is attached via a suitable attachment method to area 130. Other attachment methods used may include rivets, magnets, hook and pin “Velcro” type fasteners, nut and bolts or screw type fasteners, or any other convenient method of attaching the hook 110 to a product to be dispensed. In some embodiments the product to be dispensed my incorporate a hook 110 in the design of the actual product meaning a separate hook assembly would not be required.

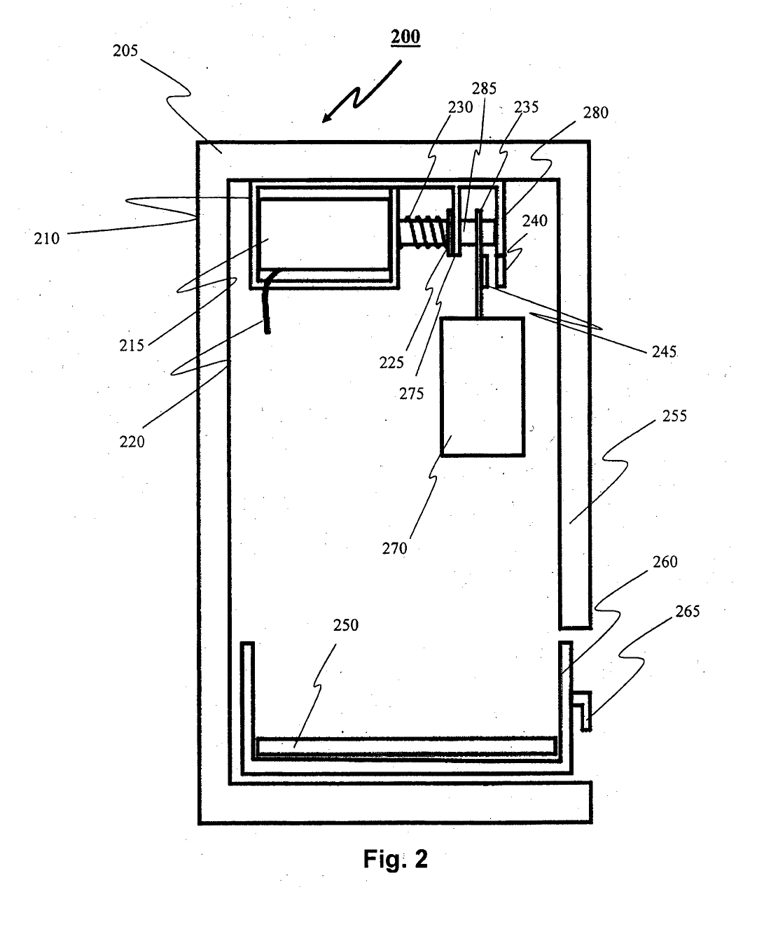

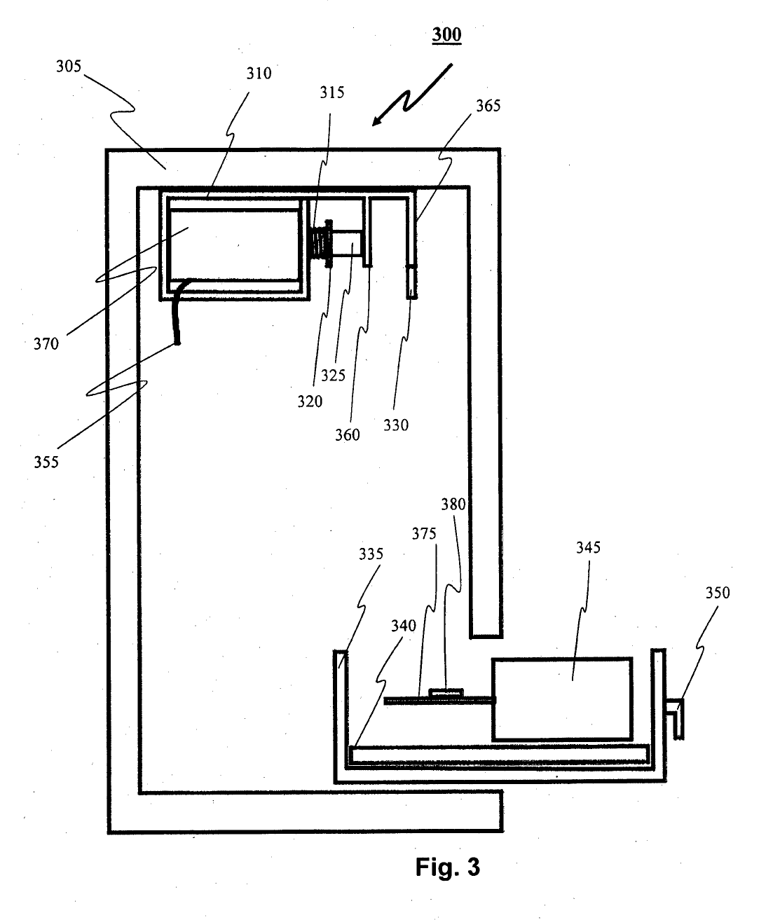

FIG. 2 shows a simplified diagrammatic illustration detailing the principal of operation of the “Hold/Release” Mechanism and Slide Drawer mechanism assembly 200. A compartment 205 is formed by suitable material. Such material may be sheet metal, plastic or other suitable materials. In certain embodiments, compartment 205 may be a refrigerated compartment, allowing the dispended products 270 to be maintained at suitable storage temperatures. The Hold/Release mechanism 210 has two states, one in which it securely holds the hook assembly and attached product 100 (FIG. 1), and the other state in which the hook assembly and attached product 100 (FIG. 1) is released and allowed to fall into the Slide Drawer for removal by the user. FIG. 2 shows the Hold/Release mechanism 210 in the Hold state, whereas FIG. 3 shows the Hold/Release mechanism 310 in the Release state. An actual embodiment of the Accurate and Secure Dispenser would typically contain a plurality of Hold/Release mechanisms, and may include several Hold/Release mechanisms located in a co-planar fashion. There may be 2 or more layers of co-planar located Hold/Release mechanisms, and there may be an optional gently inclined plane, made out of sheet metal or plastic, or other material, located between each layer of Hold/Release mechanisms. The function of such a gently inclined plane would be to prevent product dispensed from the upper layer of Hold/Release mechanisms from getting obstructed or blocked by the lower layer of Hold/Release mechanisms and products, and to guide product released from the upper layer of Hold/Release mechanisms in a controlled manner towards the Slide Drawer 265, so that it can be removed by the user.

The Hold/Release mechanism 210 consists of an electrical solenoid coil 215, which may be supplied an electrical current, of alternating current or direct current nature, via electrical leads 220. A spring 230 ensures that while the solenoid is de-energised (no current is applied at 220), the solenoid plunger shaft 285 is extended to the point that retaining washer 225 pushes against metal plate 275. Metal plate 275 has a hole drilled through it of sufficient diameter to allow passage of solenoid plunger shaft 285, but of insufficient diameter to allow passage of retaining washer 225. Spring force from spring 230 is applied horizontally between the metal casing encasing the solenoid coil 215, and the washer 225, and this spring force ensures that the end of the solenoid plunger shaft 285 extends to meet the surface 280 when the solenoid coil is de-energised. Hook Assembly 235 is hooked over the solenoid plunger shaft in the area of the shaft located between surface 275 and surface 280, and is held securely by the solenoid plunger shaft. Product to be dispensed, 270, is securely attached to Hook Assembly 235. The Hook Assembly has a tag label 245 attached or integrated within itself, and the location of this is such that it substantially aligns itself with an RFID Reader antenna 240 mounted on Hold/Release mechanism 210. In certain embodiments the tag label 245 consists of an RFID Tag. Reader antenna 240 is connected to an RFID Reader circuit, and the presence or absence of the RFID tag can be determined by the RFID reader circuit and associated processing circuitry. In certain embodiments, where it is desirable to save the costs of having a disposable RFID tag, the RFID tag can be directly applied to the RFID reader antenna surface 240. Instead of an RFID tag being applied at 245, a conductive material such as a foil label may be applied, its close presence to 240 having the affect of de-tuning the RFID tag positioned on the RFID Antenna at 240, and resulting in a “no tag read” situation being observed by the RFID reader. In this way, the Hold/Release RFID sensor arrangement may function in two modes, one mode being able to detect and confirm exactly which RFID tag is present, the other mode being merely able to detect the presence or absence of a product. The mode being able to detect which RFID tag is present is preferable in critical applications such as dispensing medications, since the system is able to reference a central database and confirm that the product relating to the particular RFID tag present is the correct product to be positioned at that particular product slot, and safeguards can be built in to ensure that the correct product is always dispensed. However in cost sensitive, non-critical applications, such as snack food vending, it may be preferable to operate the embodiment in the proximity sensing mode, which will avoid the disposal of RFID tags.

Enclosure 205 has a front panel 255, which may be made of any suitable material. In some embodiments this may be transparent material such as glass to allow visual inspection of the contents of the dispenser. Front panel 255 may be opened by authorised personnel such as refill personnel or maintenance personnel. Front Panel 255 may be hinged and securely locked, and access may be made possible via any convenient security mechanisms, including but not limited to keys, RFID access card, fingerprint, iris or other biometric access methods, keypad code entry etc. In some embodiments, a co-planer collection of Hold/Release mechanisms 210 may be located on a slide rail mounted tray, allowing the collection of Hold/Release mechanisms to be slid outwards to the frontal outside of enclosure 205, making refill operation easier. The refill attendant simply hooks the hook assembly of the replacement product on to the shaft 285. Certain embodiments may contain a feedback mechanism to confirm to the refill attendant that the correct product has been refilled. This may include for example an LED indicator located on the Hold/Release mechanism, with a Green LED indicating the correct product has been loaded, and a Red LED indicating an incorrect product has been loaded. There may also be an audible alarm warning sounded in the case of an incorrect product being loaded. The RFID antenna 240 will periodically read the tag 245 on a continually intermittent basis, and will update the status of the feedback indicators automatically.

FIG. 3 shows the “Hold/Release” Mechanism 310 in “Release” state. When power is applied to the solenoid coil 370 it exerts a magnetic force on the solenoid plunger shaft 325, which counteracts the spring force of spring 315, resulting in the plunger shaft 325 being drawn into the housing of the solenoid coil 370. This withdrawing action is sufficient so that shaft 325 no longer supports the Hook Assembly supporting Hook Assembly 375 and the attached product 345. As a result the Hook Assembly 375 and attached product 345 falls, via force of gravity, to the slide drawer 335. Slide drawer 335 may include a shock absorbing material 340 which absorbs the impact of the falling product 345 and cushions its landing preventing any damage to the product. This shock absorbing material may consist of any suitable material, including but not limited to foam rubber, air filled materials or sponge-like materials. Once the item has been released into the slide tray, the user may pull handle 350, resulting in the slide drawer 335 sliding out sufficiently from the enclosure to allow access to the dispensed product by the user. In certain embodiments, a further RFID reader antenna may be incorporated into the slide drawer itself. For example, an RFID antenna may be incorporated into the base of the drawer in a position underneath the shock absorbing material 340. Additional antennae may optionally be placed on the sides of the slide drawer 335 to detect the RFID tag if it was angularly misaligned with respect to the horizontal orientation. The Slide Drawer mounted RFID antenna or antennae may provide additional confirmation to the system that the correct item has been dispensed, since the presence of the dispensed product in the dispensing drawer would be detected. If the incorrect item or incorrect quantities of items was detected by the slide drawer located RFID antenna, then an alarm status could be set and access to the slide drawer could be denied via a suitable locking mechanism, preventing the user from pulling out the tray and accessing the dispensed products.

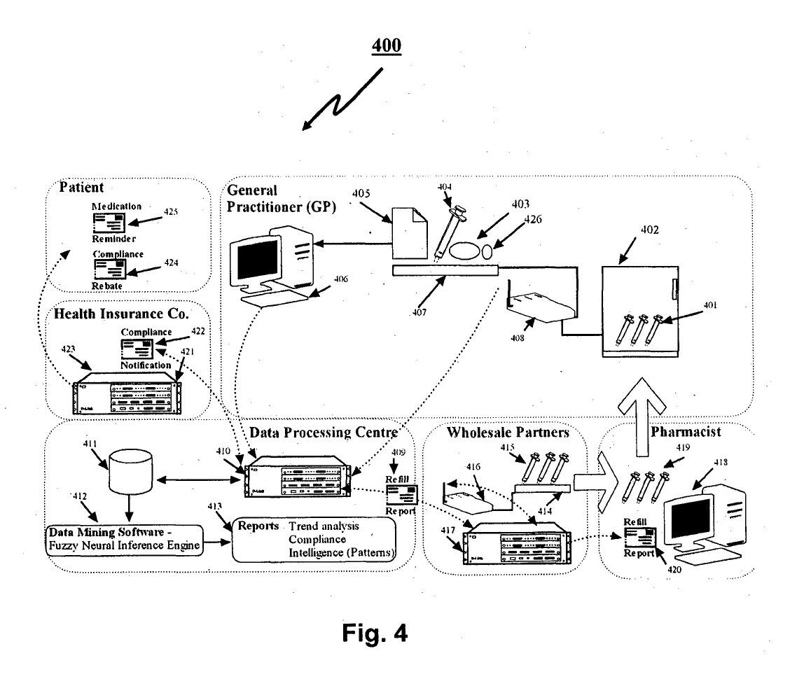

FIG. 4 is a block diagram illustrating an embodiment of the present invention, connected to other devices to form Accurate and Secure Dispensing Network 400. This embodiment is described with respect to dispensing prescription medication, although the invention is not limited to this type of application, and other types of products could be dispensed, In this particular embodiment as illustrated, the embodiment is operating in full RFID Inventory Management mode, with each product to be dispensed having an RFID Tag attached to its Hook Assembly (as opposed to the “Proximity Sensing” mode of operation where the tag is mounted directly onto the RFID antenna and a foil tag is used on the product). The Accurate and Secure Dispensing Compartment is illustrated as 402 in FIG. 4. Products requiring dispensing 701 are located inside the compartment 402. A controller unit, 408, comprises of an RFID reader, a microprocessor controller, memory, communications interface, General Purpose Input Output (GPIO) controller capable of controlling various devices. Controller 408 may further comprise an RF switching device capable of switching the RFID reader's RF output connection between several antennae, such a device is commonly referred to as an RF Multiplexer (hereinafter referred to as a “Multiplexer”). The RFID reader is coupled to the RF multiplexer and is configured to individually read RFID tags located proximal to the RFID antennae. Controller 408 may be connected to a computer network comprising either other controllers similar to 408, or to other computers, either locally on a Local Area Network, or remotely via an Internet connection, Virtual Private Network connection, wireless data or other convenient communications networking medium. Controller 408's RF multiplexer has several RF output connections connected to the RFID antennae located on the Hold/Release mechanisms located in Dispenser 402. It is thereby able to read the Tag ID numbers and any other stored memory data of RFID tags associated with products hanging on each Hold/Release Mechanism. It may optionally have a connection to a temperature sensor located in the enclosure, so that it may monitor and report temperature and possibly other environmental data such as humidity, to a central server for control and monitoring purposes. Controller 408 is connected electrically to the various solenoid coils for all the Product Hold/Release Mechanisms and door lock mechanisms of 402 enabling it full control of product dispensing and compartment access for product retrieval, refilling and maintenance operations. In certain embodiments, controller 408 may also provide monitoring and control functionality for refrigeration equipment used to cool the compartment. Controller 408 has one or more RFID Antenna outputs for connection to one or more RFID antennae 407 located in an area accessible to the user (i.e. not inside the secured product storage compartment area). This area may be located outside the compartment or alternatively inside the user accessible slide drawer, or at any other convenient location where it may be readily accessed by users. This RFID antenna or antennae is hereinafter referred to as the “Transaction Reader”. Antenna 407 may be located on the front panel of compartment 402, or alternatively at any other convenient location. This RFID antenna 402 is used for a number of functions of the present embodiment. These may include: Access control to compartment 402; Control of dispensed product 401 to only authorised users and Collection of data concerning the identity of persons to whom products are dispensed.

Authorised refill personnel may present their RFID access card 426 (herein referred to as a “Refill Card”) within range of this RFID antenna in order to gain access to the compartment 402. When the Refill Card 426 is presented the controller 408 will be placed in a special control mode referred to as “Refill Mode”, in which the machine is configured to accept new replacement products. Other methods to activate Refill Mode may also be used, instead of, or in addition to the RFID access card method, these additional methods including but not limited to keypad entry of a pass-code, biometric identification (for example finger print reading, iris scanning or hand geometry recognition), or key/lock mechanisms. The access door for maintenance and refilling is automatically unlocked when in Refill Mode. The refill personnel can then replace the hold/release mechanisms that do not have products with a new product by hanging the Hook Assembly of the new product onto the Hold/Release mechanism's Solenoid plunger shaft. Once the new Hook Assembly is attached, the RFID reader antenna detects the presence of the new RFID Tag. Controller 408 reports the presence of this new tag to a central database on a central server 410, via wired or wireless network connections. The central server 410 then associates the new RFID Tag ID number with a particular product, as previously entered into the central database, for example by the product wholesaler's RFID inventory system 416. The central server then communicates the product particulars relating to the RFID Tag ID number back to controller 408. Controller 408 may then be configured to perform a check whereby the product loaded, as identified by the RFID Tag, is compared with the product expected to be loaded, as pre-configured in the system software running on controller 408. If the product type are the same, then the controller 408 may generate a confirmation signal, for example a Green coloured LED indicator, to indicate to the refill personnel that the correct product has been loaded. If the result of the check is that the product types are not the same, the Controller 408 may generate an alarm signal notifying the refill personnel of the problem, for example a Red LED indicator located close to the Hold/Release indicator may be activated, and an audible alarm tone may also be generated.

In certain embodiments, it may be preferable to allow flexibility in the type of product assortment that can be loaded, and not limit this to particular types of products. In this case the product check described above may be modified so that rather than generate an alarm signal when a different type of product is loaded than what is expected, the system software would instead be configured to automatically update the database entry for the product type located on the particular Hold/Release mechanism. This arrangement would prevent dispensing errors, since any product information displays (e.g. LCD Displays) would display updated information concerning the products loaded onto the Hold/Release mechanism, and the system would know what type of product was being dispensed on each Hold/Release mechanism, and would only dispense the correct type of product.

RFID Antenna 407 can also be used to determine which products are to be dispensed. In example system 400, an authorised person, such as a Medical General Practitioner (GP), can use a computer terminal 406 to enter in prescription medication information into a central database. This information may include a patients name and the type and quantity of medication prescribed to the patient. Some of the information may be stored locally to preserve patient confidentiality, for example the customer name may be stored locally, with only a unique prescription identification number, and the corresponding medication prescribed being stored remotely. This allows the dispenser 402 to access required information without releasing private patient information. Alternatively, in some embodiments all information may be stored in the central database with security and encryption methods employed to preserve confidentiality of patient information. The database entry of the prescription data by the GP, and the issuing of a unique identifier corresponding to the prescription data, is hereinafter referred to as the “electronic prescription”. Once the GP has entered the electronic prescription, the embodiment offers several alternative methods of utilising the electronic prescription in order to access the medication stored in dispenser 402. Various methods are used to ensure secure and accurate dispensing of medications by dispenser 402, to fill the electronic prescription with the correct medication to the correct individual as detailed in the electronic prescription database records. These methods may be used individually or applied together in combination in order to provide increased security. These methods are discussed below:
1. The software may generate an electronic pass-code corresponding to the electronic prescription database entry, with this pass-code being entered into a keypad mounted near or on the front panel of dispenser 402 by the authorised user. Upon entering the correct pass-code on the keypad, Dispenser 402 may be configured, via its embedded firmware, to dispense the correct medication.
2. The GP's computer system 406 may be configured to associate a particular RFID Tag and associated RFID Tag ID sequence to a particular electronic prescription database entry. Each RFID Tag has a unique Tag ID sequence, and the system software can make an entry in the database connecting this Tag ID with a particular electronic prescription entry. Upon presentation of the said RFID Tag within reading range of RFID antenna 407, the system controller 408 can reference the Electronic Prescription record entry in the central database corresponding to the Tag ID sequence captured from the Tag presented. Controller 408 may then dispense the correct medication according to the electronic prescription record. Before dispensing medications, it may optionally seek further security credentials, for example the pass-code entered corresponding to the Electronic Prescription, or biometric or other security validation. Optionally, the software may further encode various items of data on the RFID Tags internal memory. For example, the number of repeats may be stored as a number on the Tag memory. Each time the tag is presented to Dispenser 402, the RFID Reader antenna 407 may be configured to check that sufficient repeats exist, and to decrement the value of the stored value by one each time it dispenses medications. When the value for “number of repeats” reaches zero, then the tag would stop functioning. Alternatively, this information could be stored centrally on the database, and the record updated each time medication was dispensed. Computer printers are available that can print information onto labels containing RFID Tags embedded into the labels. This allows simultaneous encoding of information on the RFID Tag and physical printing of characters on the surface of the label. System 406 may include such a printer to allow GP's to produce printed prescriptions that include the integrated RFID Tag corresponding to the Electronic Prescription entry in the database.
3. Various Biometric Identification methods may be employed, for example Finger Print scanning or Hand Geometry scanning. Controller 408 may take the biometric information and find matches in the central database, thereafter associating the biometric information with a particular Electronic Prescription.
4. Bar Code scanning or other similar technologies may be employed for controlling the dispensing action by communicating a unique reference identifier to Controller 408, which controller 408 can then associate with a particular Electronic Prescription entry in the central database.
5. Mobile phone and wireless technologies, such as GPRS or Short Message Service (SMS) messages may be used to communicate with Controller 408, and communicating the unique reference identifier corresponding to the Electronic Prescription entry, thereby allowing Controller 408 to dispense the correct medication via Dispenser 402. In one embodiment, a computer located nearby to the Dispenser 402 has a web browser, which can be used to type in the prescription number and password. Once this data is correctly entered, a message is automatically sent to controller 408 using a convenient networking medium, for example via wireless internet connection or GPRS connection. This message may instruct controller 408 to dispense particular medications automatically via Dispenser 402. In the case of SMS messaging, a further level of security can be imposed by cross-checking the Caller ID data with the mobile phone number of the authorised person stored in the central database corresponding to the Electronic Prescription.

Each time an electronic prescription is “filled” using Dispenser 402, controller 408 communicates this transaction to central server 410. Central Server 410 is configured to provide inventory management functions, and is connected to the supply chain, ensuring automated replenishment of consumed items on a periodic basis. Billing and account information may likewise be integrated into the system seamlessly. The frequency of product replenishment is determined by the rate of usage and the number of items stored in Dispenser 402. In one embodiment, central server 410 generates automated refill reports 409 on a periodic basis and transmits these electronically to a wholesale medication vendor who dispatches the required medication periodically to the person authorised to perform the refill operation, this may be a pharmacist 418, or other suitably trusted and qualified person. RFID Labels and associated Tag ID sequences are entered into the system software via RFID Reader antenna 414 and associated controller 416, prior to despatch of goods to the refill personnel. Relevant information relating to the products, for example medication type and expiry date information is entered into the database so that the system can track medication and ensure accurate dispensing via dispenser 402.

In healthcare it is often beneficial to monitor the rates of compliance of patients to their treatment programme. In System 400, the dispenser 402 may typically be located in the GP's practicing rooms. Treatment programmes often involve a patient receiving an injection at specific intervals. Currently available methods of distribution frequently require the doctor prescribing the necessary injection mediation, and the patient thereafter needing to visit a pharmacist who then dispenses the medication, or orders the medication for the patient, who then needs to collect the medication and make another appointment to see the GP, who then administers the injection. This is an inefficient arrangement, and often results in the patient failing to collect the medication from the pharmacist, or failing to return to the GP. This arrangement negatively impacts compliance rates of such treatment programmes. One benefit of the current embodiment is that it may potentially increase compliance rates in such circumstances, since the GP is able to prescribe, and then immediately dispense the required medication via the Dispenser 402, saving the patient a trip to the pharmacist.

A further benefit of the current embodiment is the capability of the system 400 to monitor compliance rates automatically. Each time that an electronic prescription is “filled” via dispensing the required medication by Dispenser 402, the controller 408 communicates an electronic message detailing this transaction that has occurred. The central server 410 may be configured to automatically generate a compliance notification 422 based on this event, which may be transmitted to interested and authorised parties, who may therefore keep electronic records of the compliance of a particular patient, as well as gather more generalised (and anonymous) statistics in order to analyse overall rates of compliance for particular medication types and treatment programmes. Data mining software 412 is used to analyse database records 411. Such software may use advanced mathematical analysis techniques, including Fuzzy neural Inference engines, neural network analysis, statistical analysis and other techniques to find patterns and trends in the underlying data. In such cases, privacy may be assured by omitting the patient name and particulars, and limiting the analysis to general statistical data. Mathematical analysis software, also referred to as “Data Mining” software, may be used to analyse the data in order to find trends and patterns in the data. For example, the software may discover common attributes between doctors who have low treatment Compliance rates, making it possible to make suggestions to remedy the situation. This aspect of the current embodiment has the potential of generating useful medical reporting 413, which may be used for the betterment of human health.

In one embodiment of the present invention, compliance notifications 422 may be transmitted to an authorised third party computer system. This allows the authorised third party to monitor compliance of patients to a particular treatment programme. Furthermore, it allows for the possibility of the third party introducing incentive schemes to encourage higher rates of treatment compliance. For example, in one embodiment, a Health Insurance Computer System 423 may be connected to the present embodiment's system, and configured to automatically generate a financial rebate 424, which may reduce the financial burden for the treatment compliant patient, thereby rewarding the patient for their compliance with the programme, and further encouraging higher rates of compliance.

The current embodiment may further aid in increasing compliance rates by allowing for automated reminders 425 to be sent to patients utilising the system 400, such reminders being, for example, to attend the GP for their medication to be administered. Such reminders may be sent by any convenient means, including but not limited to Mobile phone SMS messages, email and automated phone calls (for example using Interactive Voice Response (IVR) technologies).

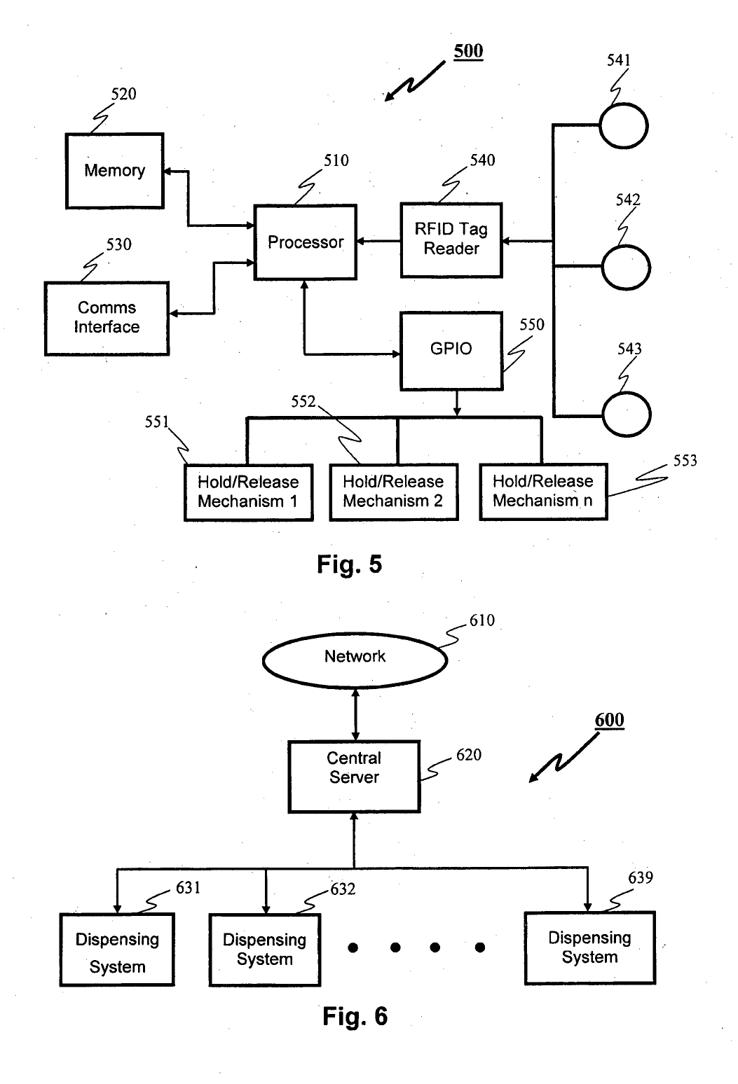

FIG. 5 is a block diagram illustrating apparatus 500 for the accurate and secure dispensing of products, according to an embodiment of the present invention; the apparatus 500 is herein referred to as the Controller unit. For removal of doubt, this is the same apparatus discussed in the earlier embodiment and referred to as the “controller” in FIG. 4 (Label 408).

Controller 500 features an RFID Tag Reader 540. The RFID Tag Reader 540 is connected, via a suitable RF transmission line (such as Coaxial Cable), to one or more RFID Reader antennae, shown as 541, 542 and 543. In certain embodiments, where more than one RFID antennae is used, the Controller 500 may utilise a suitable RF switching device, such as an RF Multiplexer device, to switch a single RFID Reader to several RFID antennae. Other embodiments may utilise multiple RFID Tag Readers instead of using an RF Multiplexer. Another embodiment may use a combination of the two methods, with several RFID readers each connected to an RF Multiplexer, allowing a large number of RFID antennae to be connected. Some of the plurality of RFID antennae (shown as 541, 542, 543 in FIG. 5) are located on the Hold/Release mechanisms discussed earlier, with each Hold/Release mechanism having typically a single RFID antenna dedicated to detecting the product tag hanging on it. One or more of the RFID antennae (541, 542, 543) are located outside the compartment, this being for the detection of RFID access cards, electronic prescription RFID tags or other RFID tags designed to provide control and access functionality for the Controller 500. This particular RFID Antenna is hereinafter referred to as the “Transaction Reader”. In certain embodiments, the transaction reader may be located inside the slide drawer mechanism. The one or more RFID Tag readers 540 are connected to a processor 510 which controls the RFID tag reader and receives the data from the RFID tag reader. The connection between 540 and 510 can be any convenient interface known to those skilled in the art, such as Serial TTL, RS232, SPI etc.

The apparatus 500 may optionally further comprises a display (not shown) under control of the processor 510 for reporting information relating to the stock in the enclosure. For example, the display may indicate to a doctor or nurse the last item of medication that was dispensed. The display may indicate other data concerning the items dispensed, such as the medication type, expiry date etc. The processor 510 may comprise any general purpose microprocessor as typically used in embedded computing applications and may run embedded C code, or even a full embedded operating system such as embedded Linux or Microsoft Windows CE.NET. The display may comprise a liquid crystal display (LCD), light emitting diode (LED) display, or any other display type known in the art.

Operation of the apparatus 500 is performed under the control of the processor 510, which executes a software application program stored in the memory 520. The apparatus 500 may be configured to determine the stock inventory of the dispensing machine periodically (e.g., once every 10 seconds). Furthermore, in certain embodiments, the apparatus 500 may be configured to determine the stock inventory of an enclosure upon receipt of an electronic message received from a remote location. Dispensing of products stored on the plurality of Hold/Release Mechanisms (shown as 551, 552 and 553), is controlled by Processor 510, usually via a General Purpose Input Output Bus (GPIO) 550, which may be connected to suitable electrical circuitry to provide electrical signals of the correct voltage and current to operate the Hold/Release mechanism's Solenoids and the various locking mechanisms of the dispensing apparatus. Sensors would usually also be connected to Processor 510 via GPIO 550. Various sensors may be used to determine the open/closed status of the dispensers slide drawer, refill and maintenance access doors. These sensors and others monitoring data, such as internal compartment temperature and status of refrigeration apparatus, may all be remotely monitored and logged via the master control software. This software may operate on a remote server and be connected via a suitable wired or wireless computer network connection. All data sent and received by Controller 500 are communicated via the Communications Interface 530, which connects Controller 500 to a host computer system. All functions, including dispensing products, locking and unlocking, stocktaking and monitoring of sensors can be controlled through remote control via the Communications interface 530. In some embodiments, the temperature of a refrigerated dispensing compartment may be adjusted automatically or via remote control using the host computer system, in order to allow for energy savings, routine defrosting and other possible advantages such as reduced maintenance costs, higher reliability etc.

The Host computer system (also referred herein as the “Central Server”, may be located locally or remotely, or there may be several host computer systems at different locations, allowing for redundancy and fault tolerance. Each product dispensed by the apparatus may be reported on an optional display, by way of an audible beep or spoken announcement, and/or via the communications interface 530 to a host computer system. Data transmitted to the host computer system may be relayed so as to make it available to authorised users via the internet, using a convenient access device, such as a web browser, internet equipped mobile phone device, PDA device, or similar such type of device. SMS technology may also be used to allow mobile phone users to receive information relating to the product dispensed, and to allow authorised users the ability to control dispensing of products using their mobile phone.

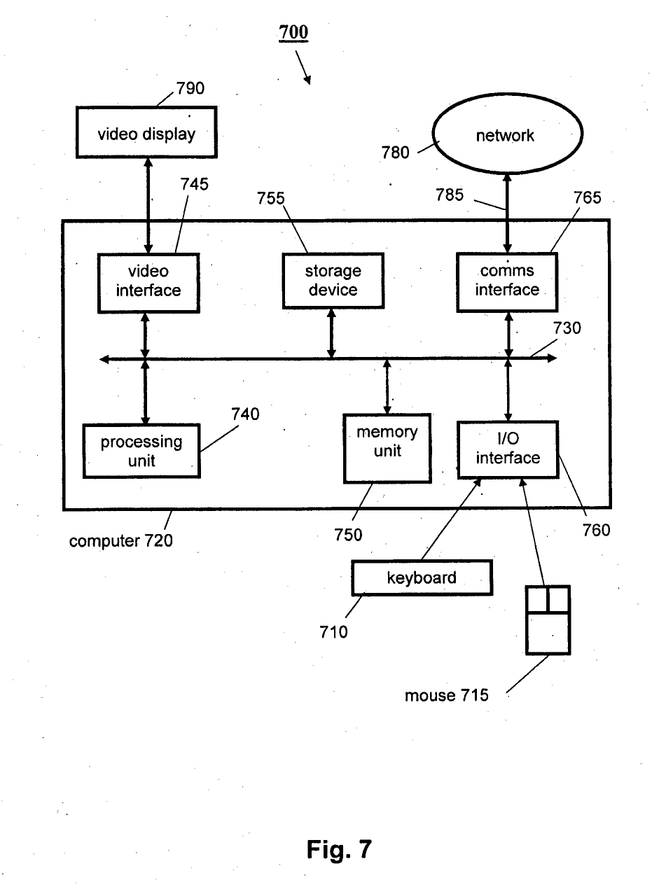

FIG. 6 shows a block diagram of a system 600 for Accurate and Secure Product Dispensing in multiple locations. The system 600 comprises a central server 620 coupled to multiple Accurate and Secure Product Dispensing Systems 631, 632, . . . 639. Each of the systems 631, 632, . . . 639 may correspond to the apparatus 500 as shown in FIG. 5. The systems 631, 632, . . . 639 are coupled to the central server 620 using any convenient networking method. These methods may include a wired network (e.g., CAT5, CAT6, Homeplug PNA, CATV wiring interface, twisted pair, mains signalling), a wireless network (e.g., 802.11, wireless GPRS) or any other networking medium, including the Internet and a Virtual Private Network (VPN).

The central server 620 comprises a computer system such as a personal computer (PC), which may be coupled to other host systems such as partner Wholesalers computer servers, Health Insurance computer servers, GP's computer systems, Pharmacist's computer systems etc. This connection may be implemented via network 610, which may consist of any convenient networking method. Such methods may include cabled or wireless local area network (LAN), Internet, VPN or any other available and/or suitable coupling means.

The central server 620 can produce refill and tamper reports. Electronic Data Interchange (EDI) messages may also be automatically generated and sent to suppliers for maintenance of stock levels.

The central server 620 may comprise an integrated web server, or be connected to an external web server via XML web services or any other suitable means of data integration with the external web server, The web application running on the web server may allow authorised users to view various levels of information depending upon a password access level. The information may, for example, relate to sales data, inventory data, expiry dates of items, maintenance data and operational status. The web application running on the web server may comprise management tools to assist in management of the operation, including stock levels, automatic ordering of stock required from suppliers via email messages, EDI messages or any other means of communication.

The central server 620 may also comprise an integrated SMS gateway, or may be connected to an external SMS gateway. Using the SMS gateway, messages such as medication reminders, to remind patients to visit their GP for their medication injection may be sent. Stock control and any other messages that may be of interest can be sent to other interested partners. Messages may also be transmitted via email, SMS or to wireless devices as determined by the software application running on the central server 620 or a software application running on another computer system connected to the Central Server 620, via a wired or wireless network, such as an Internet connection.

The central server 620 may be connected to a wireless network such as GPRS or 802.11 to enable access to the system via wireless handheld devices. The software application running on the central server 620 enables access of inventory and other information into the system via wireless handheld devices.

The central server 620 software application may be connected to an external database server via a wired or wireless private network, the Internet or a Virtual Private Network (VPN). The database may contain information relevant to many healthcare sites having the Inventory and Compliance system 600 installed. Analysis and data mining of the data is possible using advanced mathematical techniques, and valuable insights can be gained into healthcare practices, patient behaviour, treatment compliance and many other aspects.

Advantageously, embodiments of the present invention enable accurate and secure Product Dispensing of all the items within the Accurate and Secure Product Dispensing network, thus facilitating safe, secure and accurate dispensing of products intolerant to dispensing errors, such as medications. Furthermore, the system provides automated stocktaking, refill reports for all healthcare sites, expiry date management, in near real-time across a plurality of healthcare sites.

Any number of Accurate and Secure Product Dispensing Systems and Central Servers may be practiced. Certain central servers may be deployed to perform different processing or communication tasks. Moreover, multiple central servers may be practiced to provide load-balancing and/or redundancy.

FIG. 7 is a schematic representation of a computer system 700 that can be used to practice the Central Server 620. Specifically, the computer system 620 is provided for executing computer software for managing multiple Accurate and Secure Product Dispensing Systems 631, 632 . . . 639. The computer software executes under an operating system such as MS Windows XP™ or Linux™ installed on the computer system 700.

The computer software involves a set of programmed logic instructions that may be executed by the computer system 700 for instructing the computer system 700 to perform predetermined functions specified by those instructions. The computer software may be expressed or recorded in any language, code or notation that comprises a set of instructions intended to cause a compatible information processing system to perform particular functions, either directly or after conversion to another language, code or notation.

The computer software program comprises statements in a computer language. The computer program may be processed using a compiler into a binary format suitable for execution by the operating system. The computer program is programmed in a manner that involves various software components, or code means, that perform particular steps of the methods described hereinbefore.

The components of the computer system 700 may comprise a computer 720, input devices 710, 715 and a video display 790. The computer 720 comprises a processing unit 740, a memory unit 750, input/output (I/O) interface 760, communications interface 765, a video interface 745, and a storage device 755. The computer 720 may comprise more than one of any of the foregoing units, interfaces, and devices.

The processing unit 740 may comprise one or more processors that execute the operating system and the computer software executing under the operating system. The memory unit 750 may comprise random access memory (RAM), read-only memory (ROM), flash memory and/or any other type of memory known in the art for use under direction of the processing unit 740.

The video interface 745 is connected to the video display 790 and provides video signals for display on the video display 790. User input to operate the computer 720 is provided via the input devices 710 and 715, comprising a keyboard and a mouse, respectively. The storage device 755 may comprise a disk drive or any other suitable non-volatile storage medium.

Each of the components of the computer 720 is connected to a bus 730 that comprises data, address, and control buses, to allow the components to communicate with each other via the bus 730.

The computer system 700 may be connected to multiple apparatuses for controlling the dispensing of items from associated dispensing enclosures, and determining the RFID tags present in the RFID reader fields and implementing the program logic of the present embodiment, via the communications interface 765 using a communication channel 785 and a network 780. The network 780 typically, but not necessarily, comprises a private network such as CAT5, CAT6, Homeplug PNA, CATV wiring interface, twisted pair, mains signalling, 802.11 wireless network, or wireless GPRS, Internet and/or a Virtual Private Network (VPN).

The computer system 700 may also be connected to other computer systems either via the communications interface 765 or another similar communications interface (not shown). Such connection is typically, but not necessarily, via internet or and/or a Virtual Private Network (VPN).

The computer software program may be provided as a computer program product, and recorded on a portable storage medium. In this case, the computer software program is accessible by the computer system 700 from the storage device 755. Alternatively, the computer software may be accessible directly from the network 780 by the computer 720. All or part of the computer software program may be hosted on a remote computer system and may be executed on the remote computer system as a web application for access by the computer 720. In any case, a user can interact with the computer system 700 using the keyboard 710 and mouse 715 to operate the programmed computer software executing on the computer 720.

The computer system 700 has been described for illustrative purposes. Accordingly, the foregoing description relates to an example of a particular type of computer system suitable for practising the methods and computer program products described hereinbefore. Other configurations or types of computer systems can be equally well used to practise the methods and computer program products described hereinbefore, as would be readily understood by persons skilled in the art.

In one embodiment, prescription medication items to be dispensed may be tagged with an RFID tag to allow comprehensive inventory control and high accuracy dispensing. The data stored on the RFID tag is associated with particular records stored in a database. These records include fields relating to the type of medication, dosage etc. Furthermore the records include information as to which health care facility the items were sent to. They may also have data related to the specific patient that this medication is for, which would be of particular use in the case of medication which has been “customised” for a particular patient, which is increasingly the trend in modern pharmaceutical technology. In some cases particular data can be written to the actual tag memory itself, since many RFID tags have user programmable memory available. Expiry dates, may be managed through the database also, and the system may automatically generate expiry notices to warn doctors to remove expired medications from their compartments.

An embodiment of the present invention includes a device to allow a particular patient to be identified to a particular dispensing system, hereinafter referred to as a Patient Identification Item. Patient Identification Items are tagged with an RFID tag, with the data stored on said tag associated with a particular record in a patient database. By placing said Patient Identification item within the range of sensitivity of the RFID Reader antenna located outside the dispensing compartment, it is possible to determine which patient is requesting medication dispensing, and for the system to advise the central computer server of this data. One possible Patient Identification Item consists of a small tag with RFID tag embedded within, hereinafter referred to as the Patient Incentive and Compliance Tag (“PIC Tag”). This tag allows a patient to have the system record that he has received his medication, thereby enabling various system actions. Such actions include: recording his compliance in a compliance database, automatically resetting his medication reminder, so he receives a reminder via email, phone call, short messaging service message (SMS), or other convenient messaging medium. Another action may include an automatically generated incentive rebate applied to his health insurance as an incentive for the patient to comply with the treatment program.

Certain embodiments of the present invention allow for healthcare providers to identify themselves via an RFID Identification Card, to particular Dispensing Systems, thereby allowing them control of the dispensing system, or for logging of the healthcare provider de(tails in the central server software. Healthcare Provider Identification Items are Identification Items (e.g. ID Card) with an RFID transponder (or “Tag”) incorporated into the ID Card. The data stored on the RFID tag is associated with a database record relating to the particular person and related organization providing the medical treatment, for example, the Doctor providing the treatment and administering the injection.

Certain embodiments of the present invention allow a user to associate a particular item of documentation with a particular dispensing event. Documentation Items are documents with one or more RFID tags attached or embedded into the document. For example, a document may be a treatment questionnaire completed by the doctor and patient. By placing the RFID Tagged document within the range of sensitivity of the Transaction Reader RFID reader antennae, the system is able to relate the dispensing transaction with a particular document, and transmit this data to the central server, which utilises its software to make entries in the system database, relating the particular document with the particular medication dispensing event. In certain embodiments, various ID cards (patient and/or health care provider), electronic prescription documents and/or other RFID tagged documents could be placed simultaneously in the reading field of an RFID antennae connected to Controller 500 of a dispensing system. The various simultaneously present items could be automatically registered by the system, and automatically associated together in the system software records. For example, if the patients Patient ID Tag, a Healthcare ID RFID Tag, and a tagged Questionnaire document are all simultaneously placed on or near the Transaction Reader RFID antenna, then the system may be configured to automatically associate the Patient ID Tag with a valid electronic prescription stored in the database, thereafter dispense the required medication, and thereafter associate or “bind” all the data items together as related “data objects” within the database. For example the system may, through this simple action of placing the 3 objects on the transaction sensor, determine that “Mr Smith”, whose Patient ID Tag number is “12345678” was dispensed an injection of “Drug X” on 26 Nov. 2009 at 3:15 PM at the medical practice of “Dr Gladstone”, and completed a Safety and Efficacy Report number “98765”. The completed Safety and Efficacy Report may then, for example, be mailed to a data processing centre, or entered into a website by the doctor or nurse, and the full depth of data details captured by the questionnaire would then be linked to the database by means of the documents unique reference number “98765”.

In another embodiment of the current invention, with reference to FIG. 4, a nurse or other healthcare practitioner may present a patient ID tag 403 to within range of a transaction shelf 407 in order to determine what course of treatment, dosage and medications are “due” at that time for the patient. If required, the Dispenser 402 would automatically dispense any medication required at that time, taking into consideration the timing of the last medication dispensation via retrieving this information from the central database. If the patient had already received a dosage within the prescribed time then the controller 408 could display a message, and/or provide audible spoken information, indicating that no medication was due and could advise the time when it was next due, and would not dispense any medication. The correct data could be displayed on a video display unit. This data could include the medication that needs to be administered at this time, as well as historical records relating to patient care history. This arrangement would further reduce the scope for medical errors. The additional before-mentioned benefits of compliance reporting, document capture etc. would further improve accuracy, reporting and medical records. This would dramatically reduce the incidence of medical errors involving patients receiving the incorrect medications or dosages. This solution could greatly assist hospitals, Nursing homes, patient homes as well as GP practices.

Embodiments of the present invention use Radio Frequency Identification (RFID) readers and tags to monitor stock in, and detect items dispensed from, an enclosure. ISO 15693 and ISO 14443 are evolving international standards administered by the International Standards Organisation (ISO), which RFID readers and tags may be required to comply with in certain regions or jurisdictions. ISO 15693, in particular, is an evolving global open standard for ‘vicinity’ RFID or ‘smartlabel’ applications in the 13.56 MHz frequency range. Philips Semiconductors and Texas Instruments produce the ‘ICODE’ and ‘Tag-it’ range of RFID products, respectively, which conform to ISO 15693, and may be used to practice embodiments of the present invention. The ‘ICODE’ product has a reading range of approximately 1 m and includes anti-collision measures that enable multiple RFID tags to be read substantially simultaneously. It should be noted, however, that RFID devices that operate in other frequency bands and that meet other standards or no standards at all may also be used to practice embodiments of the present invention.

The RFID tags attached to each item may be read-only or read/write. Read-only tags typically provide a substantially unique identification number when read that can be associated with an individual item or item-type by a software program executed by the apparatus for Accurate and Secure Product Dispensing. Read/write tags may be encoded with various information such as an expiry date for an item. This enables automatic monitoring of expiry dates relating to items being dispensed and alerting of items require replacing.

As would be understood by persons skilled in the art, the number, shape, dimensions and location of the RFID antennae may vary according to the internal geometry of the dispensing system the RFID antennae are fitted to and the materials used in the manufacture of the dispensing machine. Multiple antennae may be connected to a single RFID tag reader. Any combination of physical size or location of antennae may be used to achieve the desired RFID read or read/write coverage based on the internal geometry of a particular enclosure. The RFID antennae may be designed and/or installed in a manner that minimises communication with RFID tags located outside the enclosure.

RFID Antennae used may typically be of a “loop antennae” type, such as those commonly used with low frequency RFID devices that operate in the 125 KHz range and HF (13 Mhz range). Loop antennae typically comprise multiple turns of an electrical conductor (e.g., copper wire or PCB copper tracks) with take-off leads or Coaxial RF waveguide for connection to an RFID tag reader. However, other types of antennae may be practiced in accordance with the operating frequency range of the particular RFID devices used. For example, an RFID antenna may comprise a printed circuit board with tracks laid out in a specific pattern to maximise RF transmission and/or reception at a particular frequency that the RFID devices operate at. At higher operating frequencies, YAGI and patch antennae are typically practiced. A YAGI antenna comprises a linear arrangement of elements, whereas a patch antenna is a flat square or rectangular shaped antenna.

Certain embodiments use passive tags on the items. Benefits of passive tags include lower cost and the existence of anti-collision protocols that allow many passive tags to be read simultaneously within the field of a reader. Passive tags or transponders obtain energy to operate from a reader, via one or more energising field antennae. Provision of an energising field somewhat complicates the design of the reader or antennae and two design options are generally possible. The first option, known as a bistatic reader, utilises two antennae for a particular coverage area, one to receive the signal and the other provide the energising field. The second option, known as a monostatic reader, uses the same antenna to receive the signal and provide an energising field for a particular coverage area.

The preferred embodiment uses a monostatic type of reader, with one antenna to cover a particular coverage area within the dispenser unit. The benefits of this arrangement include a more compact antenna arrangement and more uniform coverage at ranges close to the antenna. A compact RFID antennae, typically using a PCB material with copper tracks in a simple loop pattern, may be used and mounted on the Hold/Release mechanism as illustrated in FIG. 2. A switching circuit may be employed to switch the various antennae synchronously so that the reader progressively reads tags located on the various Hold/Release mechanisms. Alternatively, several antennae may be electrically connected to provide simultaneous coverage several Hold/Release mechanisms.

Embodiments are possible utilising a bistatic RFID readers that employ two separate antennae to cover a particular coverage area.

Certain embodiments may use active RFID tags that may be read and written to by an RFID reader. While active RFID tags are not generally economically practical for the present application, advances in microelectronic fabrication and associated technologies as well as increased demand and economies of scale could see active RFID tags becoming more viable. The benefits of active RFID tags include simplified reader design, reduced reader cost and less possibility of poor coverage areas within a Dispensing system due to tags having their own power source and thus not having insufficient power when placed in an area of insufficient energising field.

Apparatuses and systems have been described herein for Accurate and Secure Dispensing of Products from enclosures and refrigerated enclosures, sometimes referred to as Dispensing Systems. Furthermore, Apparatus and systems have been described for managing the Medical Treatment and Treatment Compliance of patients prescribed medications, ensuring correct dosage and medication types are administered to patients, and increasing the quantity and quality of medical data captured and processed. However, the foregoing description provides exemplary embodiments only, and is not intended to limit the scope, applicability or configurations of the invention. Rather, the description of the exemplary embodiments provides those skilled in the art with enabling descriptions for implementing an embodiment of the invention. Various changes may be made in the function and arrangement of elements without departing from the spirit and scope of the invention as set forth in the claims hereinafter.

The claims defining the invention are as follows:

1. A product dispenser for dispensing a product, the dispenser including:
a compartment; and
a product hanging arrangement located within the compartment, the hanging arrangement including a retractable hanging member upon which the product can be hung.

2. A product dispenser as claimed in claim 1, wherein the hanging arrangement further includes a solenoid which, upon actuation, retracts the hanging member so that the product falls from the hanging member.

3. A product dispenser as claimed in claim 2, further including a drawer located at the base of the compartment for receiving the fallen product and which can be opened so that the product can be retrieved.

4. A product dispenser as claimed in claim 1, further including a RFID reader for reading a RFID tag of the product.

5. A product dispenser as claimed in claim 4, further including a controller configured to detect the identity of the read RFID tag and to generate an incorrect product alarm responsive to the detected identity not matching a predetermined identity thereby indicating that an incorrect product has been loaded.

6. A product dispenser as claimed in claim 5, wherein the product is a medicinal product, and the controller is configured to retract the hanging member only upon the detected identity relating to a prescription.

7. A product dispenser as claimed in claim 4, wherein the product includes a foodstuff or beverage, and the dispenser further includes a controller configured to detect the absence of the read RFID tag and generate a refill alarm.

8. A product dispenser as claimed in claim 1, further including:
a plurality of other product hanging arrangements;
RFID antennae located proximal respective hanging arrangements;
a RF multiplexer arrangement in communication with the antennae; and
a RFID reader coupled to the RF multiplexer and configured to individually read RFID tags located proximal the RFID antennae.

9. A product dispenser as claimed in claim 1, further including the product, the product including a consumable and a hanger for hanging the consumable on the hanging member.

10. A product dispenser as claimed in claim 9, wherein the hanger includes a hook, and either an RFID tag to be read by a RFID reader or a conductor to be sensed by a proximity sensor.

11. A product dispenser as claimed in claim 1, wherein the compartment is refrigerated.

12. A product dispenser as claimed in claim 1, wherein the product dispenser is a hotel minibar.

13. A product dispenser as claimed in claim 12, wherein the minibar can be coupled to a hotel Property Management System (PMS) to thereby enable the dispensed product to be automatically charged to an account.

14. A product dispenser as claimed in claim 1, wherein the compartment includes a transparent front portion.

15. A product dispenser as claimed in claim 14, further including a plurality of other product hanging arrangements, the hanging arrangements being actuated to dispense like products sequentially toward the front portion.

16. A product dispenser as claimed in claim 1, further including a proximity sensor for sensing the presence or absence of a conductor of the product.

17. A product dispenser as claimed in claim 1, further including a touch screen or other like user interface to facilitate selection of the product to be dispensed.

18. A product dispenser as claimed in claim 1, further including authorization means for enabling authorized access to the compartment.

19. A product dispenser as claimed in claim 18, wherein the authorization means includes any one or more of a key, a RFID access card, a fingerprint authenticator, an iris authenticator a biometric access means, and a keypad for receiving a entry code.

20. A product for a product dispenser, the product including a hanger for hanging upon a retractable hanging member of the dispenser.
